(19) United States
(12) Patent Application Publication
(10) Pub. No.: US 2012/0149541 A1
(43) Pub. Date: Jun. 14, 2012

(54) Bowed Industrial Roll With High Strength Bearing For End Spool

(76) Inventor: Charles C. Moschel, Charlotte, NC (US)

(21) Appl. No.: 13/309,980

(22) Filed: Dec. 2, 2011

Related U.S. Application Data
(60) Provisional application No. 61/421,789, filed on Dec. 10, 2010.

(51) Int. Cl. F16C 13/00

(52) U.S. Cl. 492/47

(57) ABSTRACT

An industrial roll includes: a stationary axle having a stepped profile and a bowed longitudinal axis, with a thicker internal section and a thinner end section; an end spool rotatably mounted on the axle; and a first thick ball bearing and a second thin ball bearing, wherein the first ball bearing is mounted between the spool and the thin section of the axle, and the second ball bearing is mounted between the spool and the thick section of the axle.

### RELATED APPLICATION

This application claims priority from and the benefit of U.S. Provisional Patent Application No. 61/421789, filed Dec. 10, 2010, the disclosure of which is hereby incorporated herein in its entirety.

### FIELD OF THE INVENTION

The present invention is directed generally to industrial rolls, and more particularly to end bearings for bowed industrial rolls.

### BACKGROUND OF THE INVENTION

Industrial rolls are commonly used to transport webs, such as belts, sheets, and the like. A typical industrial roll is mounted on an axle and rotates about the axis defined by the axle. The web being transported contacts the roll and is conveyed in a direction tangent to the surface of the roll.

In some industrial environments, rather than being a cylinder with a straight longitudinal axis, the roll has a bowed longitudinal axis. This type of roll is commonly used in the papermaking industry, where the bow in the roll removes wrinkles and enables even tension to be experienced by both the center and the edges of an endless web of paper passing over the roll. Such rolls typically comprise many straight cylindrical shell sections that are mounted on a bowed axle through rotatable bearings.

Traditionally, bowed rolls have used very thin section deep groove radial ball bearings inside the rolls to mount the spools to the axle, with perhaps as many as 30 to 40 bearings being present per roll. A thin section bearing is required since it must fit between the large diameter non-rotating axle and the small inner diameter of the spool. Because the section of the bearing is thin, the bearing has reduced load carrying capacity compared to thicker bearings of similar outside diameters.

For most of the bearings in a bowed roll the use of a thin section bearing is not an issue since the load applied by the web is typically quite small. However, the end bearings, one on each end of the roll, are often subject to additional operating loads and environmental stresses that can shorten the running life of the bowed roll. Such operating loads can include axial thrust from sleeve compression or sleeve shrinkage and drive belt tensions. Environmental loads can include contamination with water, paper stock, sizing or caustics, as well as localized heating by infrared dryers in some cases. The axial loading may be particularly problematic, as deep groove radial ball bearings are not designed to withstand significant thrust loading, and it is quite common to see rolls returned with one or both end bearings in some state of failure.

The end spool of a conventional bowed roll, designated broadly at 10, is shown in FIG. 1. The roll 10 includes a stationary axle 12, the end spool 14, a plurality of common spools 15 (only a portion of one common spool 15 is shown herein), and a sleeve 16 that extends the length of the roll 10. The end spool 14 is rotatably mounted to the axle 12 via two ball bearings 17a, 17b, which include two ball bearing tracks 18a, 18b in which balls 20a, 20b reside; the balls 20a, 20b are also received in tracks 22a, 22b in the axle 12. The ball bearing tracks 18a, 18b are radially equidistant from the axis defined by the axle 12, as are the ball bearing tracks 22a, 22b. The balls 20a, 20b are also of the same size. Typically, ball bearings identical to the ball bearings 17a, 17b are used to mount the common spools 15 on the axle 12.

It may be desirable to provide an end bearing configuration that is better able to withstand the rigors experienced by end bearings.

### SUMMARY OF THE INVENTION

As a first aspect, embodiments of the present invention are directed to an assembly for an industrial roll. The assembly comprises: a stationary axle having a stepped profile, with a thicker internal section and a thinner end section; an end spool rotatably mounted on the axle; and a first thick ball bearing and a second thin ball bearing, wherein the first ball bearing is mounted between the spool and the thin section of the axle, and the second ball bearing is mounted between the spool and the thick section of the axle. In this configuration, the ball bearings can provide additional resistance to the stresses experienced by the end spools of a roll.

As a second aspect, embodiments of the invention are directed to an assembly for an industrial roll, comprising: a stationary axle having a stepped profile and a bowed longitudinal axis, with a thicker internal section and a thinner end section; an end spool rotatably mounted on the axle; and a first thick ball bearing and a second thin ball bearing, wherein the first ball bearing is mounted between the spool and the thin section of the axle, and the second ball bearing is mounted between the spool and the thick section of the axle.

As a third aspect, embodiments of the present invention are directed to an industrial roll, comprising: a stationary axle having a stepped profile, with a thicker internal section and a thinner end section; a plurality of common spools rotatably mounted on the axle; an end spool rotatably mounted on the axle; and a first thick ball bearing and a second thin ball bearing, wherein the first ball bearing is mounted between the spool and the thin section of the axle, and the second ball bearing is mounted between the spool and the thick section of the axle.

### BRIEF DESCRIPTION OF THE FIGURES

FIG. 1 is a partial section view of a conventional end spool of a bowed roll.

FIG. 2 is a partial section view of an end spool of a bowed roll according to embodiments of the present invention, with the external sleeve removed for clarity.

### DETAILED DESCRIPTION OF EMBODIMENTS OF THE INVENTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” or “above” the other elements or features. Thus, the exemplary term “under” can encompass both an orientation of over and under. The device may be otherwise oriented (rotated 90 degrees or at other orientations) and the spatially relative descriptors used herein interpreted accordingly. As used herein, “vertical” has the conventional meaning, i.e., upright; or at a right angle to the horizontal plane.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Where used, the terms “attached”, “connected”, “interconnected”, “contacting”, “mounted” and the like can mean either direct or indirect attachment or contact between elements, unless stated otherwise.

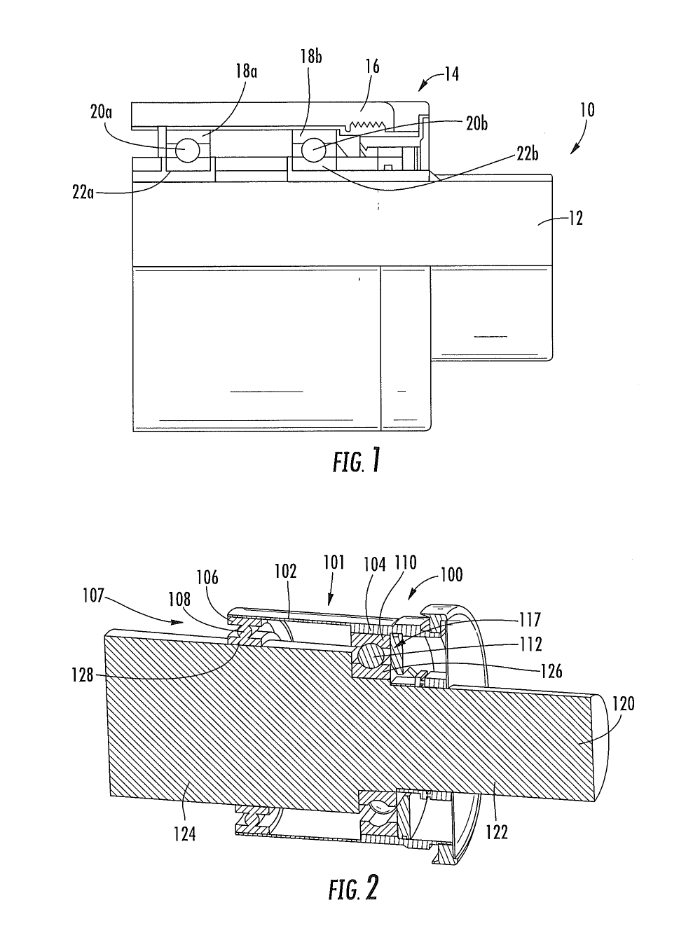

Referring now to the figures, an end spool, designated broadly at 100, can address the operating loads and environmental stress issues discussed above is illustrated in FIG. 2. End spools 100 would be attached to both ends of a bowed industrial roll such as the roll 10 shown in FIG. 1 and would sandwich therebetween a plurality of common spools 15.

As can be seen in FIG. 2, the end spool 100 has a stepped inner profile, such that the spool 100 comprises a thin section 102 and a thicker section 104. The axle 120 on which the spool 100 is mounted similarly includes a thin section 122 and a thicker section 124. The axle 120 will typically have a bowed longitudinal axis that, in combination with the common spools 15, the end spools 100, and an external rubber sleeve (not shown, and optional in some embodiments) provides a bowed surface to support a web, such as a paper web produced on a papermaking machine.

Referring again to FIG. 2, the thin section 102 of the spool 100 is mounted to the thick section 124 of the axle 120 via a thin ball bearing 107. The thin ball bearing 107 has a ball bearing track 106 attached to the thin section 102 that receives small balls 108. The thin ball bearing 107 also includes a ball bearing track 128 that is aligned with the track 106 along the longitudinal axis of the axle 120 and, as such, receives the small balls 108. Typically, the thin ball bearing 107 is substantially identical to the other ball bearings used to mount the common spools on the axle 120 (and often substantially identical to the thin ball bearings 17a and 17b shown in FIG. 1).

Referring once again to FIG. 2, the thicker section 104 of the spool 100 is mounted to the thin section 122 of the axle 120 via a thick ball bearing 117. The thick ball bearing 117 includes a ball bearing track 110 attached to the thick section 104 that receives large balls 112. The thick ball bearing 117 also includes a ball bearing track 126 that is aligned with the track 110 along the longitudinal axis of the axle 120 and, as such, receives the large balls 112.

In some embodiments, cylindrical spacers (not shown herein) may be included between some or all of the bearings. The axle may also include a “nut” or other tightening device that acts to compress the bearings along the axis of the axle. The presence of spacers and a tightening device can assist with proper location and secure mounting of the bearings.

In operation, the radially outward tracks 106, 110 are free to rotate about the longitudinal axis of the axle 120, whereas the radially inward tracks 126, 128 are fixed to the axle 120 and remain stationary relative thereto. Thus, as a web, such as a paper web, is conveyed over the common spools 15 and the end spools 100, the thin and thick sections 102, 104 of the end spool 100 are free to rotate relative to the axle 120.

The presence of the thin section axle 122 allows the use of an endmost ball bearing 117 with smaller inside diameter than, and similar outside diameter to, the ball bearing 107 and the ball bearings of the common spools. As such, bearing tracks 110 and 126 with thicker sections, and larger balls 112, comprise a thick ball bearing 117 with lower contact stresses at a particular load than the tracks 106, 128 and balls 108 of the thin ball bearing 107. Similarly, the end bearing 117 can withstand higher loads, particularly thrust loads, before reaching material stress limits or reaching excessively short fatigue life limits. This can extend the operating life of the roll as a whole.

In some embodiments, the difference in thickness of the thin and thick sections 122, 124 of the axle 120 may be between about 0.25 and 3.25 inches. In other embodiments, the ratio of the diameter between the thick and thin sections 124, 122 is between about 1.1 and 2.0. In some embodiments, the difference in thickness between the thin and thick ball bearings 107, 117 is between about 0.46 and 0.80 inches, and the ratio of the inner diameter of the thick and thin ball bearings 107, 117 is between about 1.1 and 2.0.

The foregoing embodiments are illustrative of the present invention, and are not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. An assembly for a industrial roll, comprising:
a stationary axle having a stepped profile, with a thicker internal section and a thinner end section;
an end spool rotatably mounted on the axle; and
a first thick ball bearing and a second thin ball bearing, wherein the first ball bearing is mounted between the spool and the thin section of the axle, and the second ball bearing is mounted between the spool and the thick section of the axle.

2. The assembly defined in claim 1, wherein the thicker internal section of the axle has a first diameter, and the thinner end section of the axle has a second diameter, and the difference between the first and second diameters is between about 0.25 and 3.25 inches.

3. The assembly defined in claim 1, wherein the ratio of the diameter of the thicker internal section and the diameter of the thinner end section is between about 1.1 and 2.0.

4. The assembly defined in claim 1, wherein the industrial roll is part of a papermaking machine.

5. An assembly for an industrial roll, comprising:
a stationary axle having a stepped profile and a bowed longitudinal axis, with a thicker internal section and a thinner end section;
an end spool rotatably mounted on the axle; and
a first thick ball bearing and a second thin ball bearing, wherein the first ball bearing is mounted between the spool and the thin section of the axle, and the second ball bearing is mounted between the spool and the thick section of the axle.

6. The assembly defined in claim 5, wherein the thicker internal section of the axle has a first diameter, and the thinner end section of the axle has a second diameter, and the difference between the first and second diameters is between about 0.25 and 3.25 inches.

7. The assembly defined in claim 5, wherein the ratio of the diameter of the thicker internal section and the diameter of the thinner end section is between about 1.1 and 2.0.

8. The assembly defined in claim 5, wherein the industrial roll is part of a papermaking machine.

9. The assembly defined in claim 5, further comprising a plurality of common spools mounted on the axle.

10. An industrial roll, comprising:
a stationary axle having a stepped profile, with a thicker internal section and a thinner end section;
a plurality of common spools rotatably mounted on the axle;
an end spool rotatably mounted on the axle; and
a first thick ball bearing and a second thin ball bearing, wherein the first ball bearing is mounted between the spool and the thin section of the axle, and the second ball bearing is mounted between the spool and the thick section of the axle.

11. The industrial roll defined in claim 10, wherein the thicker internal section of the axle has a first diameter, and the thinner end section of the axle has a second diameter, and the difference between the first and second diameters is between about 0.25 and 3.25 inches.

12. The industrial roll defined in claim 10, wherein the ratio of the diameter of the thicker internal section and the diameter of the thinner end section is between about 1.1 and 2.0.

13. The industrial roll defined in claim 10, wherein the industrial roll is part of a papermaking machine.

14. The industrial roll defined in claim 10, wherein the axle has a longitudinal axis that is bowed.
